(19) United States
(12) Patent Application Publication
(10) Pub. No.: US 2012/0105496 A1
(43) Pub. Date: May 3, 2012

(54) Organic light emitting display and method of driving the same

(76) Inventor: Naoaki Komiya, Yongin-City (KR)

(21) Appl. No.: 13/200,403

(22) Filed: Sep. 23, 2011

(30) Foreign Application Priority Data
Oct. 28, 2010 (KR) 10-2010-0105800

(51) Int. Cl. G09G 5/10; G09G 3/30

(52) U.S. Cl. 345/690; 345/77

(57) ABSTRACT

A method of driving an OLED, including a plurality of first sub pixels and a plurality of second sub pixels alternating each other. The method includes setting a plurality of first sub pixels to be in a non-emission state in ith (i is 1, 3, 5, . . . ) frames, selecting the plurality of first sub pixels in units of horizontal lines while sequentially supplying a first scan signal in the ith frames, setting a plurality of second sub pixels to be in a non-emission state in (i+1)th frames, and selecting the plurality of second sub pixels in units of horizontal lines while sequentially supplying a second scan signal in the (i+1)th frames. The plurality of second sub pixels are set to be in the emission state in the first ith frames and the plurality of first sub pixels are set to be in the emission state in the (i+1)th frames.

### BACKGROUND

1. Field

Embodiments relate to an organic light emitting display, and a method of driving the same. More particularly, embodiments relate to an organic light emitting display capable of being driven at a low driving frequency, and a method of driving the same.

2. Description of the Related Art

High weight and large volume are disadvantages of cathode ray tubes (CRT). Recently, various flat panel displays (FPD) have been developed that are capable of reducing weight and volume. The FPDs include liquid crystal displays (LCD), field emission displays (FED), plasma display panels (PDP), and organic light emitting displays.

Among the FPDs, the organic light emitting displays display images using organic light emitting diodes (OLED) that generate light by re-combination of electrons and holes. The organic light emitting display has high response speed and is driven with low power consumption.

The organic light emitting display includes a plurality of data lines, scan lines, and a plurality of pixels. The plurality of pixels are at intersections of power lines, arranged in a matrix. Each pixel includes an organic light emitting diode, at least two transistors, and at least one capacitor. The two transistors include a drive transistor.

### SUMMARY

Embodiments are directed to an organic light emitting display, and a method of driving the same.

An embodiment provides a method of driving an organic light emitting display including a plurality of first sub pixels and a plurality of second sub pixels that alternate with each other, including setting a plurality of first sub pixels to be in a non-emission state in ith (i is 1, 3, 5, . . . ) frames, selecting the plurality of first sub pixels in units of horizontal lines while sequentially supplying a first scan signal in the ith frames, setting a plurality of second sub pixels to be in a non-emission state in (i+1)th frames, and selecting the plurality of second sub pixels in units of horizontal lines while sequentially supplying a second scan signal in the (i+1)th frames. The plurality of second sub pixels are set to be in the emission state in the first ith frames and the plurality of first sub pixels are set to be in the emission state in the (i+1)th frames.

The plurality of first sub pixels selected by the first scan signal receive right data signals. The plurality of second sub pixels selected by the second scan signal receive left data signals. The plurality of first sub pixels are commonly coupled to a first emission control line and are simultaneously set to be in the emission or non-emission state to correspond to a first emission control signal supplied to the first emission control line. The plurality of second sub pixels are commonly coupled to a second emission control line and are simultaneously set to be in the emission or non-emission state to correspond to a second emission control signal supplied to the second emission control line.

Another embodiment provides a method of driving an organic light emitting display, including charging voltages corresponding to right data signals to a plurality of first sub pixels set to be in a non-emission state in a first frame and charging voltages corresponding to left data signals to a plurality of second sub pixels alternating with the plurality of first sub pixels and set to be in the non-emission state in a second frame. The plurality of second sub pixels are set to be in an emission state in the first frame period. The plurality of first sub pixels are set to be in the emission state in the second frame period.

An organic light emitting display includes a plurality of first sub pixels coupled to first scan lines, a plurality of second sub pixels coupled to second scan lines and alternating with the plurality of first sub pixels, a first emission control line commonly coupled to the plurality of first sub pixels, a second emission control line commonly coupled to the plurality of second sub pixels, a first scan driver for sequentially supplying a first scan signal to the first scan lines and for supplying a first emission control signal to the first emission control line in ith frames, and a second scan driver for sequentially supplying a second scan signal to the second scan lines and for supplying a second emission control signal to the second emission control line in (i+1)th frames.

The plurality of first sub pixels are set to be in the non-emission state when the first emission control signal is supplied to the first emission control line. The plurality of second sub pixels are set to be in the non-emission state when the second emission control signal is supplied to the second emission control line. The organic light emitting display further includes a data driver supplying right data signals to the jth data lines in synchronization with the first scan signal in the ith frames, the data driver supplying left data signals to the (j+1)th data lines in synchronization with the second scan signal in the (i+1)th frames.

The plurality of first sub pixels and the plurality of second sub pixels, adjacent to each other, generate light of the same color. The plurality of first sub pixels and the plurality of second sub pixels generate light of a first color, the plurality of first sub pixels and the plurality of second sub pixels generate light of a second color, and the plurality of first sub pixels and the plurality of second sub pixels generate light of a third color form a pixel.

Each of the plurality of second sub pixels may include an OLED, a pixel circuit for charging voltages corresponding to the left data signals when the second scan signal is supplied to the second scan line, the pixel circuit controlling the amount of current supplied to the OLED to correspond to the charged voltages; and a control transistor coupled between the OLED and the pixel circuit, the control transistor turned off when the second emission control signal is supplied to the second emission control line, the control transistor turned on in the other cases.

Each of the plurality of second sub pixels may include an OLED, a pixel circuit for charging voltages corresponding to the right data signals when the first scan signal is supplied to the first scan line, the pixel circuit controlling the amount of current supplied to the OLED to correspond to the charged voltages, and a control transistor coupled between the OLED and the pixel circuit, the control transistor turned off when the first emission control signal is supplied to the first emission control line, the control transistor turned on in the other cases.

### BRIEF DESCRIPTION OF THE DRAWINGS

The accompanying drawings, together with the specification, illustrate exemplary embodiments, and, together with the description, serve to explain the principles of the exemplary embodiments.

FIG. 1 illustrates an organic light emitting display according to a first embodiment;

FIG. 2 is a waveform chart illustrating the driving waveforms supplied by the first and second scan drivers of FIG. 1;

FIG. 3 illustrates frames according to an embodiment;

FIG. 4 illustrates a pixel according to the embodiment;

FIG. 5 is a circuit diagram illustrating the structure of a sub pixel according to the embodiment;

FIG. 6 illustrates an organic light emitting display according to a second embodiment; and

FIG. 7 illustrates conventional frames for realizing a 3D image.

### DETAILED DESCRIPTION

Korean Patent Application No. 10-2010-0105800, filed on Oct. 28, 2010, in the Korean Intellectual Property Office, and entitled: “Organic Light Emitting Display Device and Driving Method Thereof” is incorporated by reference herein in its entirety.

Example embodiments will not be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the inventive concept to those skilled in the art.

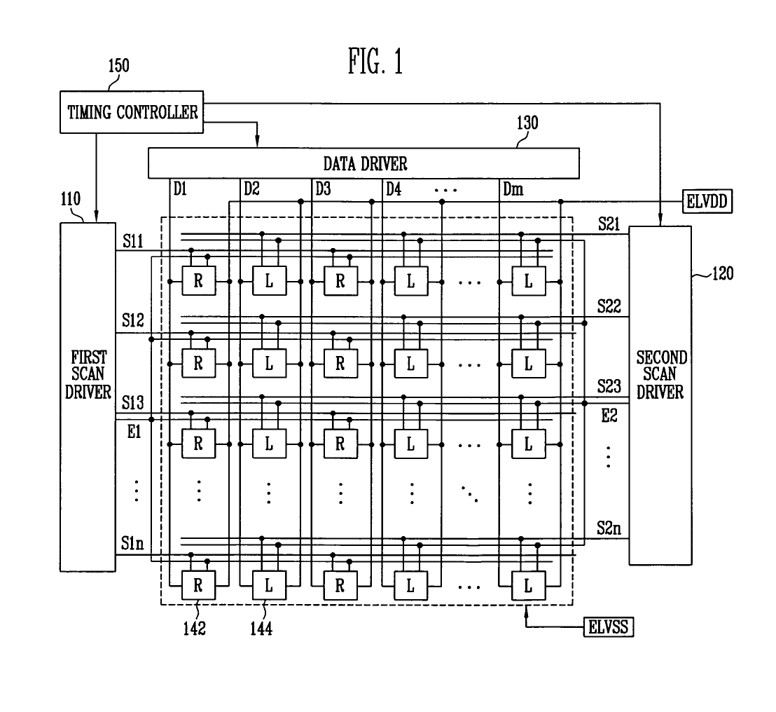

FIG. 1 illustrates an organic light emitting display according to a first embodiment.

Referring to FIG. 1, the organic light emitting display, according to the first embodiment, includes first sub pixels 142 positioned at intersections of first scan lines S11 to S1n and odd data lines D1, D3, etc., second sub pixels 144 positioned at intersections of second scan lines S21 to S2n and even data lines D2, D4, etc., a first emission control line E1 commonly coupled to the first sub pixels 142, a second emission control line E2 commonly coupled to the second sub pixels 144, a first scan driver 110 for driving the first scan lines S11 to S1n and the first emission control line E1, a second scan driver 120 for driving second scan lines S21 to S2n and the second emission control line E2, a data driver 130 for driving the data lines D1 to Dm, and a timing controller 150 for controlling the first scan driver 110, the second scan driver 120, and the data driver 130.

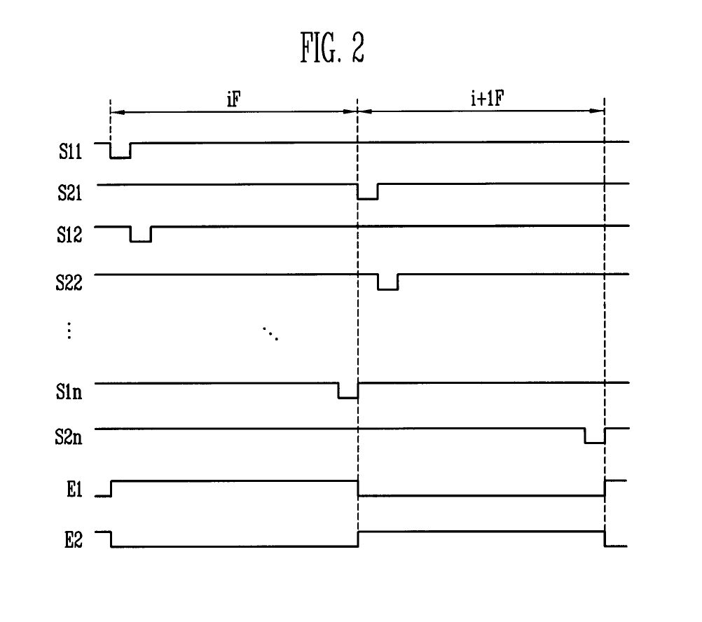

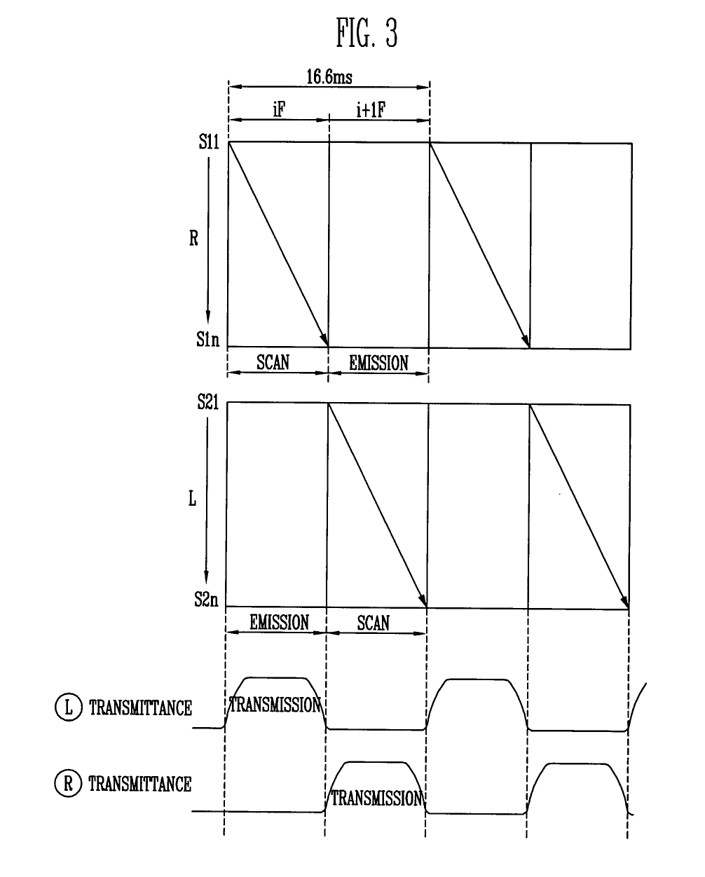

As illustrated in FIGS. 2-3, the first scan driver 110 sequentially supplies a first scan signal to the first scan lines S11 to S1n in ith (i is 1, 3, 5, etc.) frames. The first scan driver 110 supplies a first emission control signal to the first emission control line E1 in the ith frames. The first scan signal is set to have a voltage (i.e., a low voltage) at which the transistors included in the sub pixels 142 and 144 may be turned on. The first emission control signal is set to have a voltage (i.e., a high voltage) at which the transistors may be turned off.

The second scan driver 120 sequentially supplies a second scan signal to the second scan lines S21 to S2n and supplies a second emission control signal to the second emission control line E2 in (i+1)th frames. The second scan signal is set to have a voltage (i.e., a low voltage) at which the transistors included in the sub pixels 142 and 144 may be turned on. The second emission control signal is set to have a voltage (i.e., a high voltage) at which the transistors may be turned off.

The data driver 130 supplies the data signals to the odd data lines D1, D3, etc. in synchronization with the first scan signal in the ith frames. The data driver 130 also supplies the data signals to the even data lines D2, D4, etc. in synchronization with the second scan signal in the (i+1)th frames. The data driver 130 supplies the right data signals in the ith frames and supplies the left data signals in the (i+1)th frames.

According to the present embodiment, the first sub pixels 142 are coupled to the odd data lines D1, D3, etc., and the second sub pixels 144 are coupled to the even data lines D2, D4, etc. However, the present embodiments are not limited to the above. The first sub pixels 142 may be coupled to the even data lines D2, D4, etc. and the second sub pixels 144 may be coupled to the odd data lines D1, D3, etc.

The timing controller 150 controls the first scan driver 110, the second scan driver 120, and the data driver 130.

The first sub pixels 142 and the second sub pixels 144 are alternately arranged in horizontal lines. When the 3D image is realized, the first sub pixels 142 display a right image and the second sub pixels 144 display a left image.

The first sub pixels 142 are positioned between the first scan lines S11 to S1n and the odd data lines D1, D3, etc. The first sub pixels 142 are selected in units of horizontal lines to correspond to the first scan signal supplied to the first scan lines S11 to S1n in the ith frames to receive the right data signals from the odd data lines D1, D3, etc.

In the ith frames, where the first sub pixels 142 receive the right data signals, the first emission control signal is supplied to the first emission control line E1 so that the first sub pixels 142 are set to be in a non-emission state. Then, where the first emission control signal is not supplied, the first sub pixels 142 are set to be in an emission state in the (i+1)th frames.

The second sub pixels 144 are positioned between the second scan lines S21 to S2n and the even data lines D2, D4, etc. The second sub pixels 144 are selected in units of horizontal lines to correspond to the second scan signal supplied to the second scan lines S21 to S2n in the (i+1)th frames to receive the left data signals from the even data lines D2, D4, etc.

In the (i+1)th frames, where the second sub pixels 144 receive the left data signals, the second emission control signal is supplied to the second emission control line E2 so that the second sub pixels 144 are set to be in the non-emission state in the (i+1)th frames. Where the second emission control signal is not supplied, the second sub pixels 144 are set to be in the emission state in the ith frames.

When the organic light emitting display is to display three-dimensional images, a viewer views the display through shutter glasses. The shutter glasses receive light by a left lens in the ith frames where the second sub pixels 144 emit light and receive light by a right lens in the (i+1)th frames where the first sub pixels 142 emit light. The shutter glass viewer recognizes the three dimensional image supplied through the shutter glasses.

According to the present embodiments, in the period where the first sub pixels 142 emit light, the second sub pixels 144 are set to be in the non-emission state. In the period where the second sub pixels 144 emit light, the first sub pixels 142 are set to be in the non-emission state. Therefore, crosstalk is not generated. Crosstalk is a phenomenon where the left and right images are mixed with each other. According to the present embodiments, since only two frames iF and i+1 F are included in the period of 16.6 ms, the organic light emitting display may be driven at a driving frequency of 120 Hz.

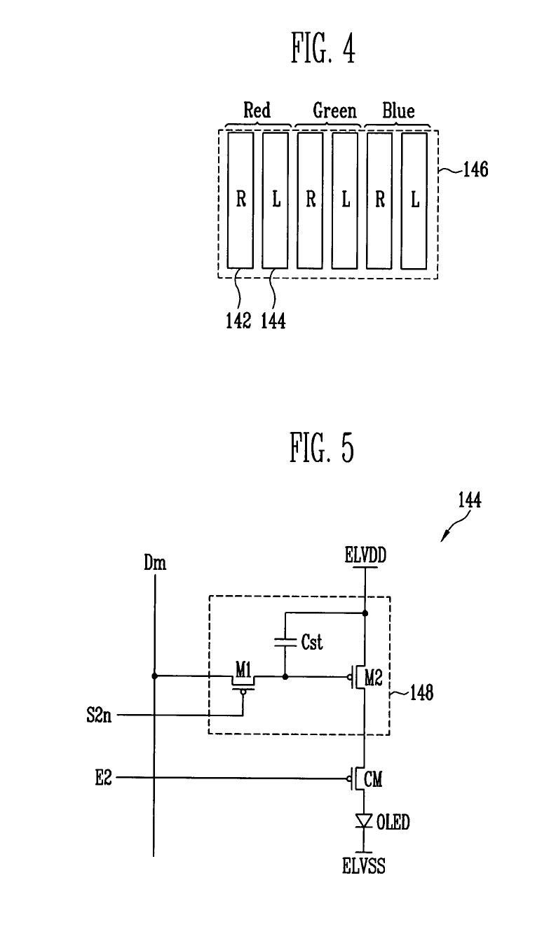

FIG. 4 illustrates a pixel according to the present embodiments.

Referring to FIG. 4, according to the present embodiments, the first sub pixels 142 and the second sub pixels 144 alternately emit light every frame. Therefore, the first sub pixels 142 and the second sub pixels 144 are positioned adjacent to each other so that a desired color image may be displayed in the ith frames and the (i+1)th frames. The color images in the ith frames and the (i+1)th frames generate light of the same color.

The first sub pixel 142 and the second sub pixel 144 for generating red (or a first color) light are formed to be adjacent to each other. The first sub pixel 142 and the second sub pixel 144 for generating green (or a second color) light are formed to be adjacent to each other. The first sub pixel 142 and the second sub pixel 144 for generating blue (or a third color) light are formed to be adjacent to each other. The three first sub pixels 142 for generating the red, green, and blue light components and the three second sub pixels 144 for generating the red, green, and blue light components constitute one pixel 146.

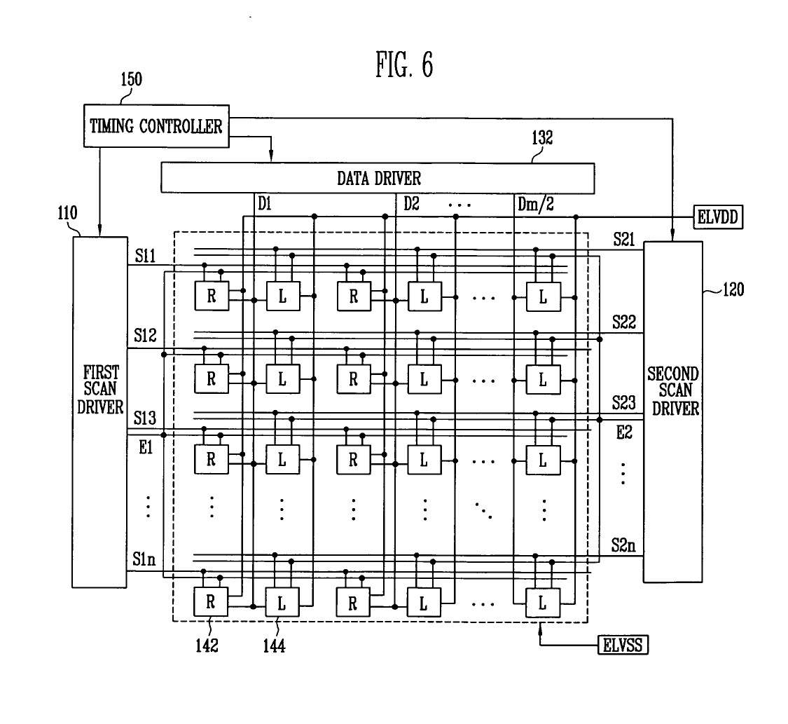

FIG. 5 is a circuit diagram illustrating the structure of a sub pixel according to the embodiments. According to the present embodiments, the first sub pixel 142 and the second sub pixel 144 are set to have the same pixel structure.

Referring to FIG. 5, the second sub pixel 144, according to the present embodiments, includes an organic light emitting diode (OLED), a pixel circuit 148 for controlling the amount of current supplied to the OLED, and a control transistor CM coupled between the pixel circuit 148 and the OLED.

The anode electrode of the OLED is coupled to the control transistor CM. The cathode electrode of the OLED is coupled to a second power source ELVSS. The OLED generates light with predetermined brightness to correspond to the amount of current supplied from the pixel circuit 148.

The pixel circuit 148 controls the amount of current supplied to the OLED. The pixel circuit 148 may be formed of various types of circuits. For example, the pixel circuit 148 may include a first transistor M1, a second transistor M2, and a storage capacitor Cst.

The first electrode of the first transistor M1 is coupled to the data line Dm. The second electrode of the first transistor M1 is coupled to the gate electrode of the second transistor M2. The gate electrode of the first transistor M1 is coupled to the second scan line S2n. The first transistor M1 is turned on when the second scan signal is supplied to the second scan line S2n to electrically couple the data line Dm to the gate electrode of the second transistor M2.

The first electrode of the second transistor M2 is coupled to a first power source ELVDD. The second electrode of the second transistor M2 is coupled to the first electrode of the control transistor CM. The gate electrode of the second transistor M2 is coupled to the first electrode of the first transistor M1. The second transistor M2 supplies the current corresponding to the voltage coupled to the gate electrode thereof to the OLED.

The storage capacitor Cst is coupled between the gate electrode of the second transistor M2 and the first power source ELVDD. The storage capacitor Cst charges the voltage corresponding to the data signal.

The first electrode of the control transistor CM is coupled to the pixel circuit 148. The second electrode of the control transistor CM is coupled to the anode electrode of the OLED. The gate electrode of the control transistor CM is coupled to the second emission control line E2. The control transistor CM is turned off when the second emission control signal is supplied to the second emission control line E2. The control transistor CM is turned on when the emission control signal is not supplied. The first sub pixel 142 is set to have the same structure, except the gate electrode of the control transistor CM is coupled to the first emission control line E1.

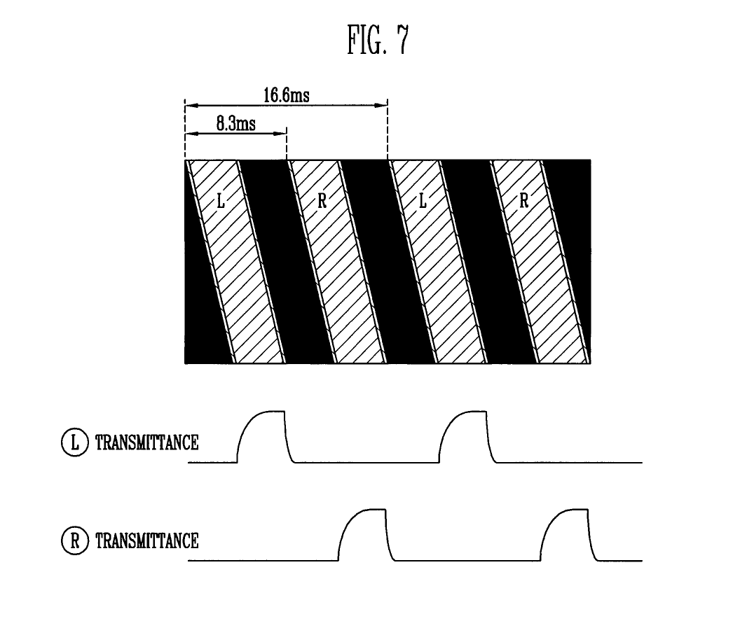

FIG. 6 illustrates an organic light emitting display according to a second embodiment. When FIG. 6 is described, the same elements as those of FIG. 1 are denoted by the same reference numerals, and detailed description thereof will be omitted.

Referring to FIG. 6, in the organic light emitting display according to a second embodiment, the data lines D1 to Dm/2 are commonly coupled to the first sub pixels 142 and the second sub pixels 144. The first sub pixels 142 and the second sub pixels 144 are formed on the same horizontal line, and positioned to be adjacent to each other. In comparison to the organic light emitting display of FIG. 1, the number of data lines D1 to Dm/2 may be reduced by half.

A data driver 132 supplies the right data signals to the data lines D1 to Dm/2 in the ith frames and supplies the left data signals to the data lines D1 to Dm/2 in the (i+1)th frames. The right data signals supplied to the data lines D1 to Dm/2 are supplied to the first sub pixels 142 in the ith frames. The left data signals supplied to the data lines D1 to Dm/2 in the (i+1)th frames are supplied to the second sub pixels 144. Since other structures and driving methods of FIG. 6 are the same as FIG. 1, detailed description thereof will be omitted.

As illustrated in FIG. 7, the organic light emitting display of a conventional organic light emitting display includes four frames in a period of 16.6 ms in order to realize a 3D image. Among the four frames, a first frame displays a left image. A third frame displays a right image. A second frame and a fourth frame display a black image. The black image displayed in the second frame and the fourth frame prevents a left image and a right image from being mixed with each other. If the left image and the right image are not mixed, crosstalk is prevented.

However, in order to have the four frames included in the period of 16.6 ms in the conventional organic light emitting display, the organic light emitting display must be driven at the driving frequency of 240 Hz. When the organic light emitting display is driven at a high frequency, power consumption increases, stability deteriorates, and manufacturing cost increases.

According to the present embodiments, in the organic light emitting display, and the method of driving the same, the first sub pixels, displaying the right image, and the second sub pixels, displaying the left image, alternately emit light based on the frame. Since the data signals are supplied to the second sub pixels in the period where the first sub pixels emit light and the data signals are supplied to the first sub pixels in the period where the second sub pixels emit light, the 3D image may be realized at a low driving frequency of 120 Hz.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the inventive concept as set forth in the following claims.

What is claimed is:

1. A method of driving an organic light emitting display including a plurality of first sub pixels and a plurality of second sub pixels that alternate with each other, the method comprising:
setting a plurality of first sub pixels to be in a non-emission state in ith (i is 1, 3, 5, . . . ) frames;
selecting the plurality of first sub pixels in units of horizontal lines while sequentially supplying a first scan signal in the ith frames;
setting a plurality of second sub pixels to be in a non-emission state in (i+1)th frames; and
selecting the plurality of second sub pixels in units of horizontal lines while sequentially supplying a second scan signal in the (i+1)th frames,
wherein the plurality of second sub pixels are set to be in the emission state in the first ith frames and the plurality of first sub pixels are set to be in the emission state in the (i+1)th frames.

2. The method as claimed in claim 1, wherein the plurality of first sub pixels selected by the first scan signal receive right data signals.

3. The method as claimed in claim 1, wherein the plurality of second sub pixels selected by the second scan signal receive left data signals.

4. The method as claimed in claim 1, wherein the plurality of first sub pixels are commonly coupled to a first emission control line and are simultaneously set to be in the emission or non-emission state to correspond to a first emission control signal supplied to the first emission control line.

5. The method as claimed in claim 1, wherein the plurality of second sub pixels are commonly coupled to a second emission control line and are simultaneously set to be in the emission or non-emission state to correspond to a second emission control signal supplied to the second emission control line.

6. A method of driving an organic light emitting display, the method comprising:
charging voltages corresponding to right data signals to a plurality of first sub pixels set to be in a non-emission state in a first frame; and
charging voltages corresponding to left data signals to a plurality of second sub pixels alternating with the plurality of first sub pixels and set to be in the non-emission state in a second frame,
wherein the plurality of second sub pixels are set to be in an emission state in the first frame period, and
wherein the plurality of first sub pixels are set to be in the emission state in the second frame period.

7. An organic light emitting display, comprising:
a plurality of first sub pixels coupled to first scan lines;
a plurality of second sub pixels coupled to second scan lines and alternating with the plurality of first sub pixels;
a first emission control line commonly coupled to the plurality of first sub pixels;
a second emission control line commonly coupled to the plurality of second sub pixels;
a first scan driver sequentially supplying a first scan signal to the first scan lines, the first scan driver supplying a first emission control signal to the first emission control line in ith frames; and
a second scan driver sequentially supplying a second scan signal to the second scan lines, the second scan driver supplying a second emission control signal to the second emission control line in (i+1)th frames.

8. The organic light emitting display as claimed in claim 7, wherein the plurality of first sub pixels are set to be in the non-emission state when the first emission control signal is supplied to the first emission control line.

9. The organic light emitting display as claimed in claim 7, wherein the plurality of second sub pixels are set to be in the non-emission state when the second emission control signal is supplied to the second emission control line.

10. The organic light emitting display as claimed in claim 7, wherein:
the plurality of first sub pixels are coupled to jth (j is an odd or even number) data lines, and
the plurality of second sub pixels are coupled to (j+1)th data lines.

11. The organic light emitting display as claimed in claim 10, further comprising:
a data driver supplying right data signals to the jth data lines in synchronization with the first scan signal in the ith frames, the data driver supplying left data signals to the (j+1)th data lines in synchronization with the second scan signal in the (i+1)th frames.

12. The organic light emitting display as claimed in claim 7, further comprising:
a plurality of data lines alternating with the first and second scan lines,
wherein the plurality of the first sub pixels and the plurality of the second sub pixels, adjacent to each other, are commonly coupled to one of the plurality of data lines.

13. The organic light emitting display as claimed in claim 12, further comprising:
a data driver supplying right data signals to the plurality of data lines in synchronization with the first scan signal in the ith frames, the data driver supplying left data signals to the plurality of data lines in synchronization with the second scan signal in the (i+1)th frames.

14. The organic light emitting display as claimed in claim 7, wherein the plurality of first sub pixels and the plurality of second sub pixels are adjacent to each other, the plurality of first sub pixels and the plurality of second sub pixels generate light of the same color.

15. The organic light emitting display as claimed in claim 14, wherein:
the plurality of first sub pixels and the plurality of second sub pixels generate light of a first color,
the plurality of first sub pixels and the plurality of second sub pixels generate light of a second color,
the plurality of first sub pixels and the plurality of second sub pixels generate light of a third color, and
the plurality of first sub pixels and the plurality of second sub pixels form a pixel.

16. The organic light emitting display as claimed in claim 11 or 13, wherein each of the plurality of first sub pixels comprises:
an organic light emitting diode (OLED);
a pixel circuit for charging voltages corresponding to the right data signals when the first scan signal is supplied to the first scan line, the pixel circuit controlling the amount of current supplied to the OLED to correspond to the charged voltages; and
a control transistor coupled between the OLED and the pixel circuit, the control transistor turned off when the first emission control signal is supplied to the first emission control line, the control transistor turned on in other cases.

17. The organic light emitting display as claimed in claim 11 or 13, wherein each of the plurality of second sub pixels comprises:
an OLED;
a pixel circuit for charging voltages corresponding to the left data signals when the second scan signal is supplied to the second scan line, the pixel circuit controlling the amount of current supplied to the OLED to correspond to the charged voltages; and
a control transistor coupled between the OLED and the pixel circuit, the control transistor turned off when the second emission control signal is supplied to the second emission control line, the control transistor turned on in the other cases.
